(19) United States
(12) Patent Application Publication
(10) Pub. No.: US 2011/0285676 A1
(43) Pub. Date: Nov. 24, 2011

(54) DISPLAY SYSTEM CAPABLE OF UPDATING AN EXTENDED DISPLAY IDENTIFICATION DATA OF AN OPTION BOARD AND METHOD THEREOF

(76) Inventor: Chia-Hsin Lin, Taoyuan County (TW)

(21) Appl. No.: 13/113,088

(22) Filed: May 23, 2011

(30) Foreign Application Priority Data
May 24, 2010 (CN) 201010192514.3

(51) Int. Cl. G09G 5/00

(52) U.S. Cl. 345/204

(57) ABSTRACT

An option board is coupled to a monitor. The option board stores a first identification code. The monitor has a second identification code. If the second identification code of the monitor is different from the first identification code of the option board, a first extended display identification data and the first identification code stored in the option board will be updated.

### BACKGROUND OF THE INVENTION

1. Field of the Invention

The present invention is related to a display system capable of updating extended display identification data and method thereof, and particularly to a display system capable of updating extended display identification data of an option board and method thereof.

2. Description of the Prior Art

When information of an output signal device is outputted by a monitor, the output signal device has to know extended display identification data (EDID) of the monitor, and transmits a corresponding timing signal to the monitor according to the EDID. The EDID includes a resolution, a manufacturer name, a serial number, an operation frequency, parameters of input images, power management, luminance, and color of the monitor.

Please refer to FIG. 1A, FIG. 1B, and FIG. 1C. Connection methods between the monitor and the output signal device (such as a personal computer or a work station) according to the prior art are described as follows. As shown in FIG. 1A, an output signal device 102 connects to a monitor 104. As shown in FIG. 1B, an output signal device 102 connects to a plurality of monitors 104 by a splitter 106. As shown in FIG. 1C, an output signal device 102 connects to a plurality of monitors 104 and switches the plurality of monitors 104 by a switch device 108. If a user wants a plurality of monitors to display the same signals/frames, the user can adopt the connection methods of FIG. 1A and FIG. 1B. However, the connection method of FIG. 1A requires a plurality of output signal devices, and the connection method of FIG. 1B usually has poor signal quality and stronger noise due to the splitter 106.

### SUMMARY OF THE INVENTION

An embodiment provides a display system capable of updating extended display identification data (EDID). The display system includes an option board and a monitor. The option board includes a first memory for storing a first EDID and a first identification code. The monitor selectively connected to the option board includes a second memory and a control unit. The second memory is used for storing second EDID and a second identification code. The control unit is electrically connected to the second memory. When the option board is electrically connected to the monitor and the second identification code of the monitor is different from the first identification code of the option board, the control unit updates the first EDID and the first identification code of the option board.

Another embodiment provides a method for updating a first EDID (extended display identification data) of an option board. The option board is coupled to a monitor and stores a first identification code. The monitor has a second identification code. The method includes reading the second identification code of the monitor; comparing the second identification code of the monitor with the first identification code stored in the option board; updating the first EDID and the first identification code stored in the option board when the second identification code of the monitor is different from the first identification code stored in the option board.

### BRIEF DESCRIPTION OF THE DRAWINGS

FIG. 1A, FIG. 1B, and FIG. 1C illustrate connection methods between the monitor and the output signal device according to the prior art.

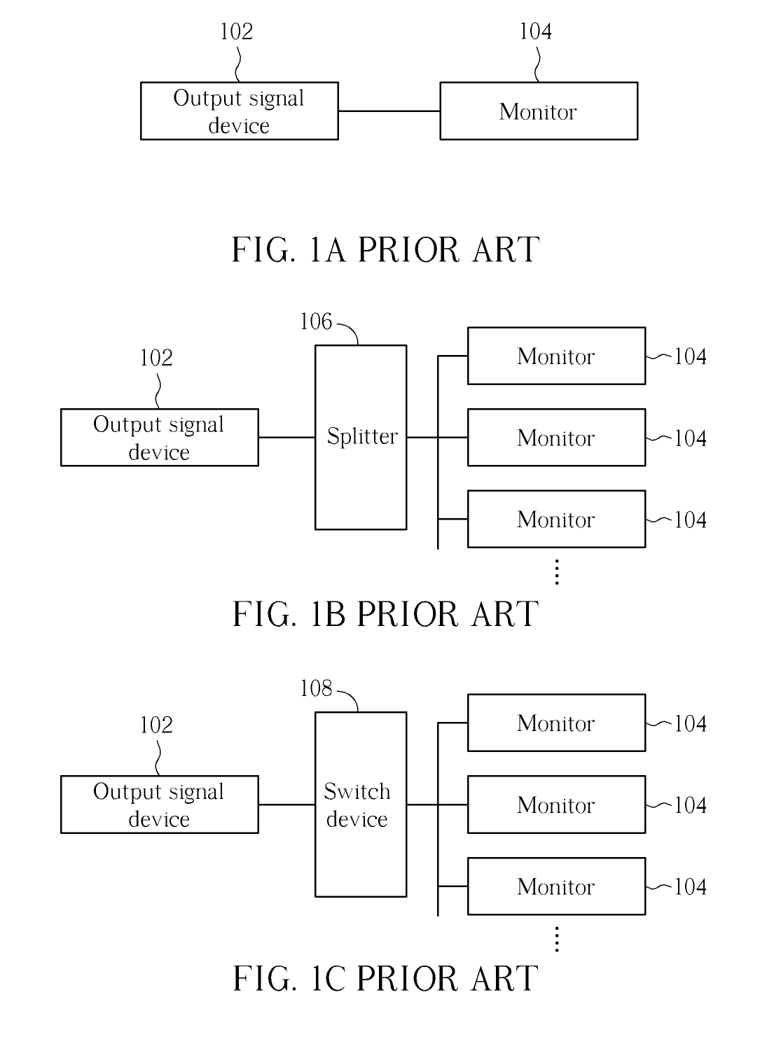

FIG. 2 illustrates a display system capable of updating extended display identification data according to an embodiment.

FIG. 3 illustrates a combination of an output signal device connecting with a plurality of monitors through a plurality of option boards according to another embodiment.

FIG. 4 illustrates a combination of a plurality of option boards, a plurality of output signal devices, and a plurality of monitors according to another embodiment.

FIG. 5 is a flowchart illustrating a method for updating extended display identification data of an option board according to another embodiment.

### DETAILED DESCRIPTION

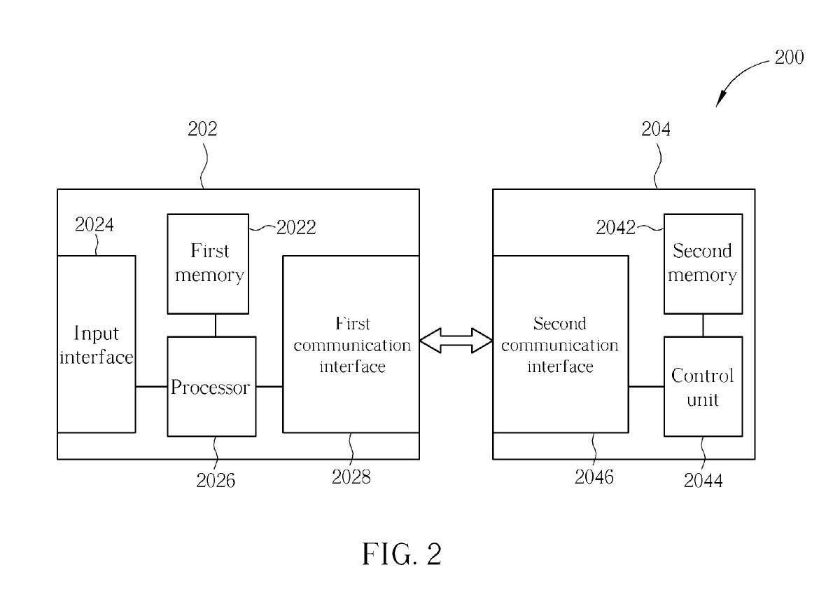

Please refer to FIG. 2. FIG. 2 illustrates a display system 200 capable of updating extended display identification data (EDID) according to an embodiment. The display system 200 includes an option board 202 and a monitor 204. The option board 202 includes a first memory 2022, an input interface 2024, a processor 2026, and a first communication interface 2028. The first memory 2022 stores a first EDID and a corresponding first identification code. The first identification code represents the monitor that the option board 202 applies for. The input interface 2024 is used for receiving a first signal. The processor 2026 is electrically connected to the first memory 2022, the input interface 2024, and the first communication interface 2028. The processor 2026 converts the first signal into a second signal, and the second signal is transmitted to the monitor 204 through the first communication interface 2028. The monitor 204 is selectively connected to the option board 202, and the monitor 204 includes a second memory 2042, a control unit 2044, and a second communication interface 2046. The second memory 2042 is used for storing a second EDID and a second identification code. The second identification code of the monitor 204 is a second model number and/or a second checksum of the second EDID of the monitor 204. The control unit 2044 is electrically connected to the second memory 2042 and the second communication interface 2046. The first communication interface 2028 is a virtual machine BUS well known in the art, and the second communication interface 2046 is a field programmable gate array (FPGA) or a complex programmable logic device (CPLD) also well known in the art. But, the present invention is not limited to the above mentioned communication interfaces. When an output signal device (such as a personal computer or a work station) outputs the first signal (such as an 8-bit YUV coding format signal well known in the industry), the input interface 2024 receives the first signal and transmits the first signal to the processor 2026, then the processor 2026 converts the first signal into the second signal for the monitor 204 to display the second signal. In addition, number of bits of the second signal is greater than number of bits of the first signal. For example, the second signal may be a 10-bit or even 12-bit RGB signal. But, the present invention is not limited to the above mentioned signals.

In addition, as shown in FIG. 2, the second identification code and the second EDID are stored in the second memory 2044 of the monitor 204 during a production/repair process. When the option board 202 is selectively connected to the monitor 204, the control unit 2044 of the monitor 204 compares the second identification code of the monitor 204 with the first identification code of the option board 202. When the first identification code does not exist, or the first identification code is different from the second identification code, the control unit 2044 of the monitor 204 utilizes the second EDID and the second identification code of the monitor 204 to update information stored in the first memory 2022 of the option board 202, so that the first memory 2022 has third EDID and a third identification code. Ideally, the third EDID and the third identification code should be as same as the second EDID and the second identification code of the monitor 204. Then, the control unit 2044 of the monitor 204 compares the third identification code of the option board 202 with the second identification code of the monitor 204. If there are any difference, the control unit 2044 of the monitor 204 repeats the above action till the third EDID and the third identification code are as same as the second EDID and the second identification code or the display system 200 is powered off suddenly.

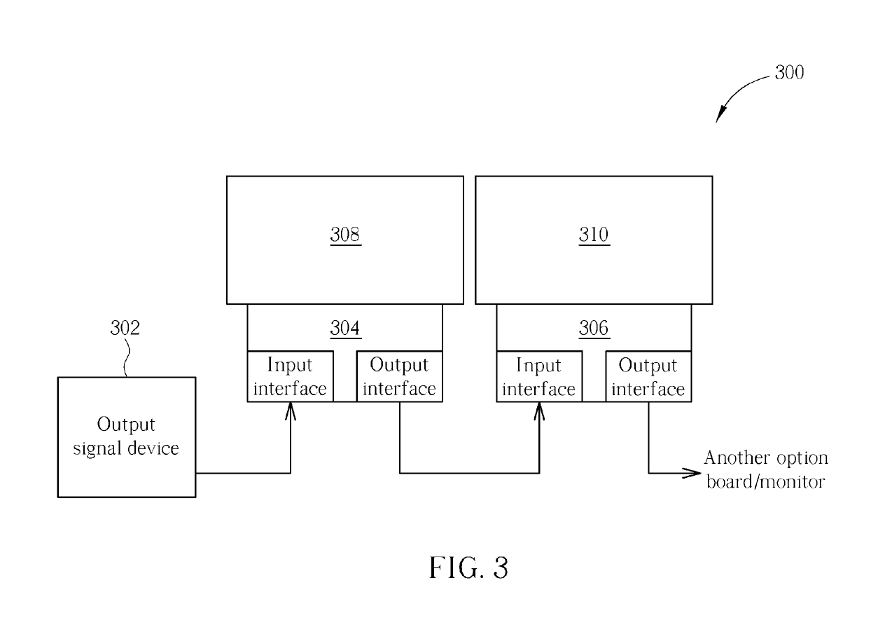

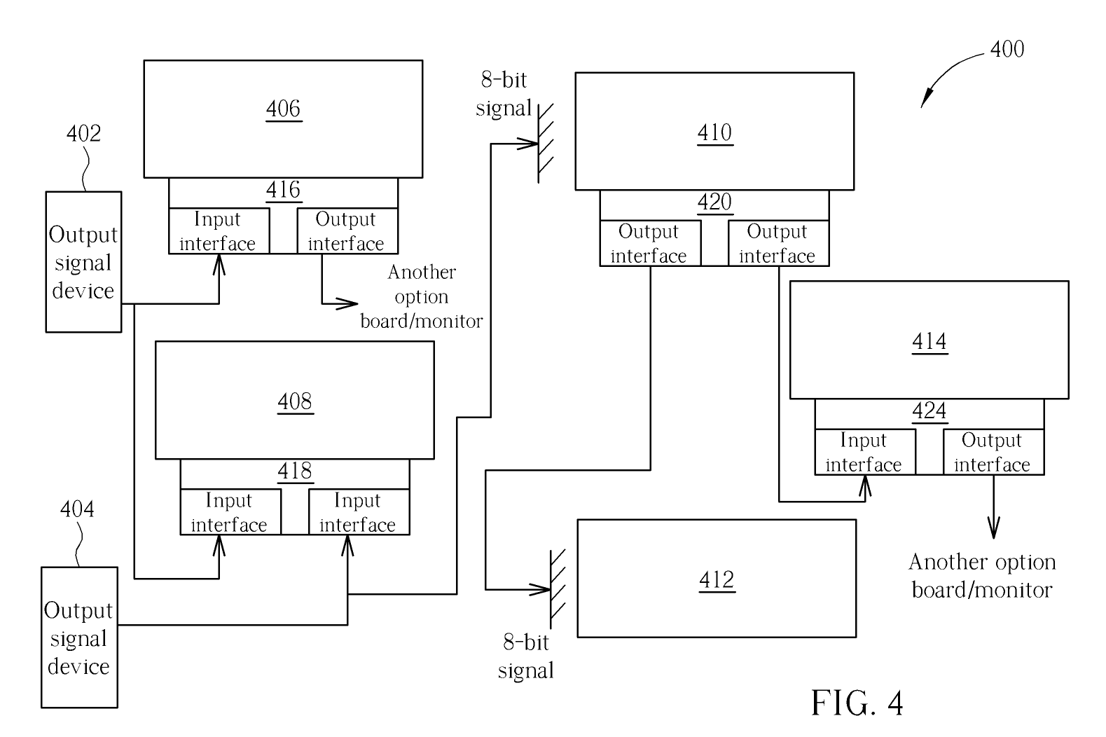

In the present invention, the option board may also have at least one output interface or have both the input interface and the output interface. Please refer to FIG. 3. FIG. 3 illustrates a combination 300 of an output signal device connecting with a plurality of monitors through a plurality of option boards according to another embodiment. As shown in FIG. 3, the combination 300 includes an output signal device 302, option boards 304, 306, and monitors 308, 310. A difference between embodiments in FIG. 3 and in FIG. 2 is that the option boards 304, 306 respectively have an output interface. Therefore, the option boards 304, 306 can communicate with or connect to another option board/monitor through the output interface thereof. In FIG. 3, the output signal device 302 outputs the 8-bit YUV coding format signal to the option board 304, and the option board 304 converts the 8-bit YUV coding format signal into a 10-bit RGB signal for the monitor 308 to display the 10-bit RGB signal. In addition, those of ordinary skill in the art can add a switch circuit for the option board 304 to output an 8-bit YUV coding format signal (not processed by the processor) or the 10-bit RGB signal (processed by the processor) to the option board 306 according to a production requirement. But, the present invention is not limited to the above mentioned signals. Please refer to FIG. 4. FIG. 4 illustrates a combination 400 of a plurality of option boards, a plurality of output signal devices, and a plurality of monitors according to another embodiment. As shown in FIG. 4, the option boards 416, 424 individually have an input interface and an output interface, an option board 418 has two input interfaces, and an option board 420 has two output interfaces. Therefore, the output signal device 402, 404 and the monitor 406, 408, 410, 412, and 414 can form the combination 400 through the option board 416, 418, 420, and 424. It should be understood that monitors 410, 412 receive signal from its video interface instead of option boards. The signal formats and the electrical connection method of the combination 400 are as same as those of the display system 200 and the combination 300, so further description thereof is omitted for simplicity. It should be understood that the present invention is not limited to the above mentioned number of the input/output interfaces.

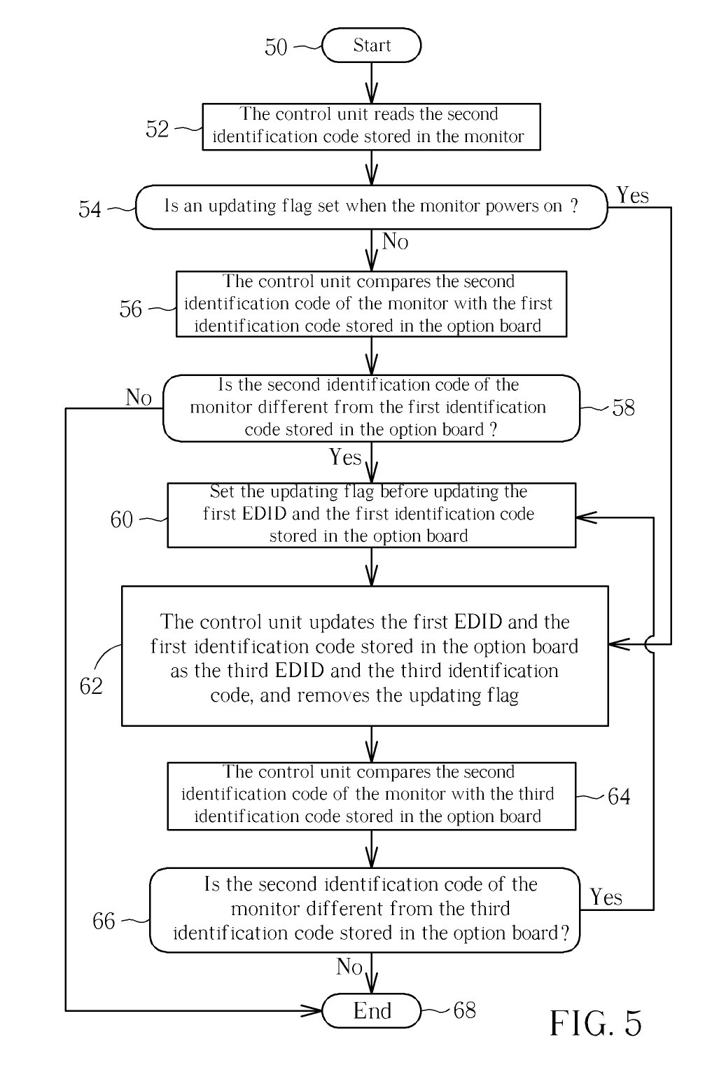

Please refer to FIG. 5. FIG. 5 is a flowchart illustrating a method for updating EDID of an option board according to another embodiment. FIG. 5 uses the display system 200 in FIG. 2 to illustrate the method. Detailed steps are as follows:

Step 50: Start.

Step 52: The control unit 2044 reads the second identification code stored in the monitor 204.

Step 54: Is an updating flag set when the monitor 204 powers on? If yes, go to Step 62; if not, go to Step 56.

Step 56: The control unit 2044 compares the second identification code of the monitor 204 with the first identification code stored in the option board 202.

Step 58: Is the second identification code of the monitor 204 different from the first identification code stored in the option board 202? If yes, go to Step 60; if not, go to Step 68.

Step 60: Set the updating flag before updating the first EDID and the first identification code stored in the option board 202.

Step 62: The control unit 2044 updates the first EDID and the first identification code stored in the option board 202 as the third EDID and the third identification code, and removes the updating flag.

Step 64: The control unit 2044 compares the second identification code of the monitor 204 with the third identification code stored in the option board 202.

Step 66: Is the second identification code of the monitor 204 different from the third identification code stored in the option board 202? If yes, go to Step 60; if not, go to Step 68.

Step 68: End.

The first identification code of the option board 202 is a first model number and/or a first checksum of a first EDID of a monitor which the option board 202 applies for. The second identification code of the monitor 204 is a second model number and/or a second checksum of the second EDID of the monitor 204. Therefore, in Step 56, when the control unit 2044 compares the second identification code of the monitor 204 with the first identification code stored in the option board 202, the control unit 2044 can compare one of the checksum and the model number at least. In addition, the checksum is 1-byte information generated by utilizing an algorithm that performs an operation on all bits of an EDID.

In Step 62, the control unit 2044 utilizes the second EDID and the second identification code of the monitor 204 to update the information stored in the first memory 2022 of the option board 202, so that the first memory 2022 has the third EDID and the third identification code which are ideally as same as the second EDID and the second identification code of the monitor 204. In Step 64, the control unit 2044 compares the second identification code of the monitor 204 with the third identification code stored in the option board 202, and determines whether the third identification code stored in the option board 202 is identical to the second identification code of the monitor 204.

In addition, when the option board 202 is electrically connected to the monitor 204, the control unit 2044 of the monitor 204 may check a state of the updating flag. If the updating flag is set, the control unit 2044 omits comparing the second identification code of the monitor 204 with the first identification code stored in the option board 202, and utilizes the second EDID and the second identification code of the monitor 204 to update the first EDID and the first identification code stored in the option board 202.

To sum up, compared with the prior art, the display system in the invention utilizes an option board to accomplish an output signal device connecting a plurality of display systems with better signal quality. Furthermore, the present invention achieves a purpose of the option board supporting a variety of monitors by automatically updating the EDID of the option board when it is plugged into the variety of monitors.

Those skilled in the art will readily observe that numerous modifications and alterations of the device and method may be made while retaining the teachings of the invention.

What is claimed is:

1. A method for updating a first EDID (extended display identification data) of an option board, the option board coupled to a monitor, the option board storing a first identification code, the monitor having a second identification code, the method comprising:
reading the second identification code of the monitor;
comparing the second identification code of the monitor with the first identification code stored in the option board; and
updating the first EDID and the first identification code stored in the option board when the second identification code of the monitor is different from the first identification code stored in the option board.

2. The method of claim 1, wherein the second identification code of the monitor is a second model number of the monitor and/or a second checksum of a second EDID, and the first identification code stored in the option board is a first model number and/or a first checksum of the first EDID.

3. The method of claim 1, wherein the first EDID and the first identification code stored in the option board is updated as a third EDID and a third identification code, and the third EDID and the third identification code of the option board are as same as the second EDID and the second identification code of the monitor.

4. The method of claim 3, further comprising:
reading the second identification code of the monitor and comparing with the third identification code of the option board after updating the first EDID and the first identification code stored in the option board as the third EDID and the third identification code.

5. The method of claim 4, further comprising:
updating the third EDID and the third identification code stored in the option board again when the second identification code of the monitor is different from the third identification code stored in the option board.

6. The method of claim 1, further comprising:
setting an updating flag before updating the first EDID and the first identification code stored in the option board when the second identification code of the monitor is different from the first identification code stored in the option board.

7. The method of claim 6, further comprising:
removing the updating flag after updating the first EDID and the first identification code stored in the option board.

8. The method of claim 6, further comprising:
reading the second EDID and the second identification code of the monitor again and updating the first EDID and the first identification code of the option board again if the updating flag is set when the monitor powers on.

9. The method of claim 8, further comprising:
removing the updating flag after updating the first EDID and the first identification code stored in the option board again.

10. A display system capable of updating EDID (extended display identification data), the display system comprising:
an option board, comprising:
a first memory for storing a first EDID and a first identification code; and
a monitor selectively connected to the option board, the monitor comprising:
a second memory for storing a second EDID and a second identification code; and
a control unit electrically connected to the second memory;
wherein when the option board is electrically connected to the monitor and the second identification code of the monitor is different from the first identification code of the option board, the control unit updates the first EDID and the first identification code of the option board.

11. The display system of claim 10, wherein the control unit updates the first EDID and the first identification code as a third EDID and a third identification code, and the third EDID and the third identification code of the option board are as same as the second EDID and the second identification code of the monitor.

12. The display system of claim 11, wherein when the second identification code of the monitor is different from the first identification code of the option board, the control unit sets an updating flag, and when the second identification code of the monitor is as same as the third identification code of the option board, the control unit removes the updating flag.

13. The display system of claim 10, wherein the option board further comprises:
at least one input interface for receiving a first signal; and
a processor electrically connected to the at least one input interface and the monitor, the processor converting the first signal into a second signal for the monitor displaying the second signal, wherein number of bits of the second signal is greater than that of the first signal.
